(19) United States
(12) Patent Application Publication
(10) Pub. No.: US 2025/0191557 A1
(43) Pub. Date: Jun. 12, 2025

(54) PLATFORM FOR FIXING MUSICAL INSTRUMENTS

(71) Applicant: P SET DI FABIO LAVELLI, LUNGAVILLA (IT)

(72) Inventor: Fabio LAVELLI, LUNGAVILLA (IT)

(21) Appl. No.: 18/843,722

(22) PCT Filed: Mar. 6, 2023
(86) PCT No.: PCT/IB2023/052075

§ 371 Date: Sep. 4, 2024

(51) Int. Cl. G10G 5/00; F16M 11/14; F16M 11/22

(52) U.S. Cl. CPC G10G 5/00; F16M 11/14; F16M 11/22

(57) ABSTRACT

The invention relates to a platform (10) for fixing musical instruments (X), wherein said platform (10) comprises a pivoting plate (4) provided with a plurality of suction cups (6) for supporting and gripping a musical instrument (X), wherein each of the suction cups (6) has an adjustable position on the surface of said plate (4), and wherein each of said suction cups (6) is connectable by a respective air connection tube (9) to a vacuum generation system (20) for fixing said musical instrument (X).

### FIELD OF THE INVENTION

The present invention relates to a platform for fixing stringed musical instruments.

### BACKGROUND

A supporting and fixing structure for supporting musical instruments is known which consists of a main aluminium beam or truss longer than the instrument, which extends below it along the longitudinal axis.

The structure includes other beams positioned transversely to the main beam on which the instrument bodies rest (thanks to adjustable screw feet).

The handle of the instrument extends along the main beam and is supported by other feet.

The instrument once supported is then made stable using at least two bands that start from the beam, embrace the instrument by wrapping it and return to the beam and a band that starts from the longitudinal beam and binds the handle.

The musical instrument once fixed to the structure is definitely stable and resistant to manual efforts.

However, if you want to perform a rotation of the instrument along the longitudinal axis, you must fix the entire beam and in particular the longitudinal beam to a clamp that grips it and is fixed to a pedestal. This allows a constrained rotation around the longitudinal axis. The rotation is carried out by manually acting on the clamp stopper to unlock it, adjust its rotation and then locking it again by acting on its stopper. Everything works but it is bound to move in 2 axes of rotation and every time you want to move the instrument you have to manually act on a stopper. In addition, to achieve that movement you need a pedestal structure since the movement needs freedom of space in the rotation zones.

The negative consequences are:
bulky structure with the presence of a pedestal that must be anchored to the ground
with the presence of the pedestal it is not possible to anchor the structure to workbenches
high weight
low versatility, i.e. difficulty in moving the structure to be moved in various areas
the movements of the structure are slow and constrained to a maximum of two axes of movement; moreover, each time to make a movement it is necessary to unscrew, position and tighten.

The instrument is fixed by wrapping it with stretched bandages with ratchets transverse to the aluminium beam anchored to the beam.

Surely the known system described above is a stable system but it has many limitations.

First of all, this known structure requires a lot of time to fix the instrument: the bands must be loosened, then the instrument must be passed through them, and finally the bands must be re-tensioned one at a time.

Secondly, the structure needs a lot of time to release the instrument: it is necessary to act on the ratchets to loosen one band at a time and remove the instrument.

Another limitation of the known structure is given by the limited possibility of freely intervening on the body of the instrument, since the latter remains wrapped in some of its areas by the bands that prevent its surface from being totally free. The presence of the bands that wrap the instrument body do not make it totally free and prevent it from performing a processing in a single operation on the entire surface of the body of the musical instrument.

There is another structure made with a mechanical clamp that tightens the handle of the musical instrument on both sides and has a height-adjustable support on which to place the back of the body of the instrument.

This keeps the instrument solid without the presence of bands.

The limits of this second known structure are:
single fixing position with tool horizontally
it is impossible to fix the instrument in the clamp in other positions but only in the handle
inability to rotate along the longitudinal axis of the instrument
when the instrument is fixed horizontally by means of the clamp, it has the possibility to rotate 360° with respect to a vertical axis but not with respect to a longitudinal axis
the few movements of the instrument once held in the clamp lead to poor working ergonomics.

The object of the present invention is therefore to create a device that is able to grasp and fasten the instruments quickly without clamps or bands, allowing total freedom of work for the operator thanks to ample possibilities of movement of the object that nevertheless remains stable on the anchorage.

A further object of the invention is to create a platform to support musical instruments and can be anchored on any workbench, even mobile.

A further object of the invention is obtaining the above result in an economical and practical way.

Other objects and advantages of the invention will become apparent from the following description.

### BRIEF SUMMARY OF THE INVENTION

The objects described are obtained from a platform for fixing stringed musical instruments, wherein said platform comprises a pivoting plate equipped with a plurality of suction cups for supporting and gripping a musical instrument, wherein each of the suction cups has an adjustable position on the surface of said plate, and wherein each of said suction cups is connectable by means of a respective air connection tube to a vacuum generation system for fixing said musical instrument.

The invention has numerous and important advantages.

In particular, the invention allows in a very short time and with very simple gestures to guarantee a fixing of the instrument by retaining it in the back without ruining the wooden surfaces keeping the front and side totally free from any mechanical clamp or binding band so that it can be worked in full freedom.

According to an embodiment of the invention, each of the suction cups is slidable along a respective through-hole obtained on the plate and is fixable in position by means of a respective fixing ring nut.

An advantage of this realization is that it allows the platform to adapt to the different sizes of musical instruments.

According to another embodiment of the invention, the vacuum generation system is a pneumatic system connectable to a pressurized air source for generating a vacuum by means of the Venturi principle.

In addition, the platform includes a consensus lever that acts on the pneumatic system to generate the vacuum and a vacuum discharge lever that allows the suction cups to be unlocked by letting air in from the outside, factors that allow rapid and effective use of the platform itself.

According to a further embodiment of the invention, the plate is connectable to a pneumatic positioner via nut. The plate, by means of a spherical play of the positioner can be inclined and oriented in each direction and pneumatically locked in the desired position. (As for example described by the same applicant in a previous invention.)

This solution makes it possible to position the musical instrument fixed to the platform in the most comfortable way for the operator who must carry out a machining on it using a 360° freedom of rotation, and of inclination in all directions of 35° with respect to the vertical axis.

Further characteristics of the invention can be deduced from the dependent claims.

Note that the prior art document DSKZ2-COMPACT by G.K. techniques describes a device for transporting and handling large loads consisting of a central base body with an almost circular metal panel shape with manual support sockets and hooks for crane support. From the central body X-branch off, 4 metal arms extendable and positionable with end Suction Cups that are connected to a pump incorporated in the central body that generates a vacuum in them. The suction cups operate so that the artifact anchors on objects with a smooth surface. The pump on board the device is battery operated and must be recharged when discharging. Lifting or moving the D1 manually or above all with the help of a lifter lifts or moves the anchored object. Device D1 weighs approximately 60 kg and cannot be lifted or moved manually by a single person. It takes more people or the help of a hydraulic lift to move said device. The said device has large and bulky dimensions. Not suitable for musical instruments. Weight too heavy to be handled by a single person.

This device cannot be used on a workbench or in a laboratory.

The said device has totally different dimensions, weight, and purpose compared to the application for musical instruments. It is a tool dedicated to industry and construction sites. The parts handled with said device must be laid or supported by structures before releasing the suction cups.

The said artifact has 360° manual rotation with stop every 45° and not in every degree not allowing meticulous and precise movements (which is suitable for the scope of movement of said device but not of the present invention dedicated to musical instruments).

The platform for musical instruments described by the present invention in coupling to the pneumatic positioner can be inclined in any direction and can rotate 360° on different axes with many more degrees of movement thanks to a spherical play and can be locked then maintaining the position chosen by the operator.

The said prior art device cannot be fixed on a workbench is a free object that must be supported manually or with a crane structure once attached to the load to be handled.

The platform for musical instruments can be fixed on a workbench and does not require other structures to move the details.

The said prior art device is mainly used for handling and installing heavy loads, it does not allow processing and maintenance on gripped objects.

The platform for musical instruments allows the fixing of the musical instrument and its convenient handling management to carry out machining and maintenance of the instruments themselves.

### BRIEF DESCRIPTION OF THE DRAWINGS

The advantages of the invention are evident from an examination of the figures illustrated in the attached tables, where:

FIG. 1 is a side view of a platform for fixing musical instruments, according to an embodiment of the present invention;

FIG. 2 is a plan view of the platform of FIG. 1;

FIG. 3 is a further side view of the platform of FIG. 1;

FIG. 4 is a further side view of the platform of FIGS. 1-3, mounted on a pneumatic positioner support;

FIG. 5 is a side view of the pneumatic positioner of FIG. 4;

FIG. 6 is a side view of a musical instrument during positioning on the platform of the invention; and

FIG. 7 is a side view of a musical instrument positioned on the platform of the invention.

### DETAILED DESCRIPTION OF THE INVENTION

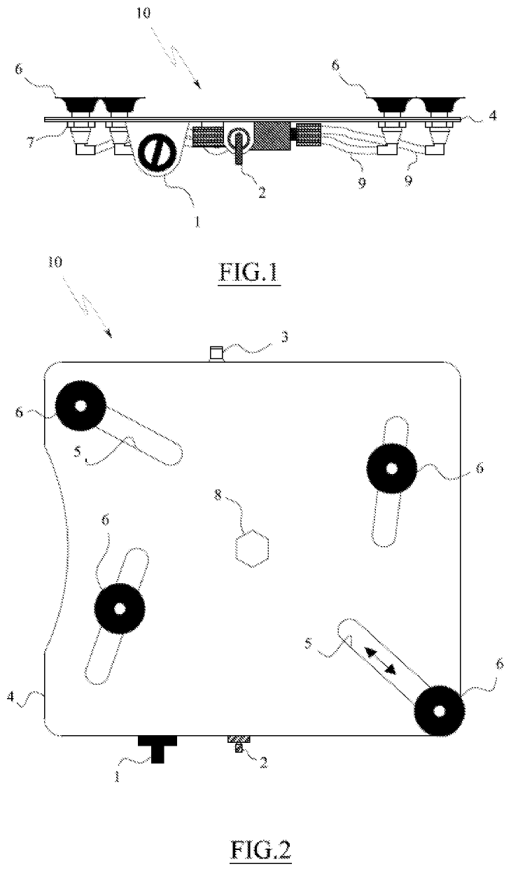

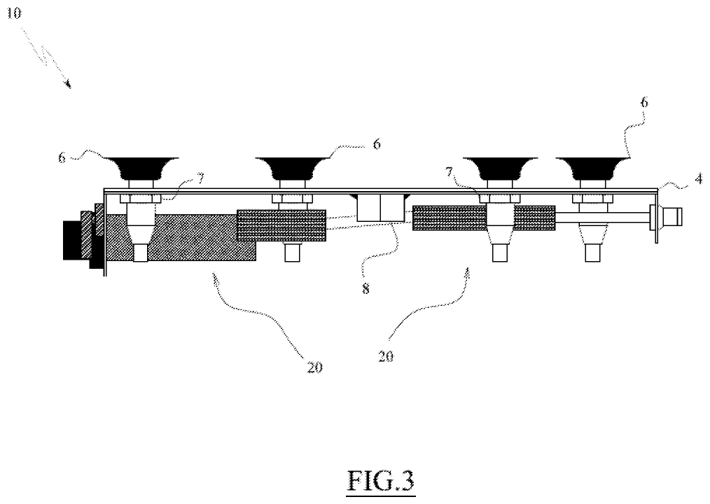

With initial reference to FIGS. 1-3, a platform for fixing musical instruments according to an embodiment of the invention is highlighted, globally indicated with the reference number 10.

The platform 10 comprises a plate 4 provided with a plurality of suction cups 6 each of which has an adjustable position.

The plate 4 is preferably made of steel with 3.5 mm thickness and is coated with soft anti-scratch material to avoid ruining musical instruments.

In addition, the instrument fixing plate 4 has small dimensions (for example 35×32 cm) that allow the operator's hands to grip it comfortably to be able to orient and position it according to needs.

Each of the suction cups 6 has an adjustable position along the surface of the plate 4 because it is slidable along a respective through-hole 5 formed on the plate 4 and can be fixed in position by means of a respective fixing ring nut 7.

The through-holes 5 are preferably four in number as visible in FIGS. 1-3 and have the function of lanes to allow the sliding and positioning of the four suction cups 6.

As better illustrated below, the suction cups 6 are connected to a vacuum generation system and are made of soft anti-trace rubber with the function of supporting the body of the instruments and holding it with the force of the vacuum.

The system for generating the vacuum located under the plate 4 is supplied with compressed air through the connection 3.

The plate 4 is in turn connected to the vacuum generation system by means of a connection 3 for compressed air supply.

The suction cups 6 have the possibility to slide along the through-holes 5 of the plate 4 to be positioned and fixed according to the different shapes and sizes of the musical instruments.

The suction cups 6 can be positioned along the through-holes 5 and fixed in position by means of respective fixing ring nuts 7.

The suction cups 6 can be connected by means of air connection tubes 9 to a pneumatic system 20 for the generation of the vacuum.

In particular, the platform 10 equipped with pneumatic system 20 is mounted on the positioner 30.

The pneumatic system 20 operates as a vacuum generator and is well collected under the plate 4 and does not come out of its edges, avoiding generating functional and invasive encumbrance.

The pneumatic system 20 is controlled by two control levers.

In particular, a consensus lever 1 that activates the pneumatic system 20 generating suction and a vacuum discharge lever 2 for opening the circuit canceling the vacuum.

These levers 1 and 2 protrude slightly from the lower edge of the plate 4.

On the opposite side of the plate 4 there is a plug-in connection 3 into which a tube connected to a compressed air source that supplies the entire pneumatic system 20 must be inserted.

A consensus lever 1 for generating the vacuum is then mounted on the plate 4, which lever is connected to the pneumatic system 20 and protrudes to the lower side of the plate 4.

Also on the plate 4 is mounted a vacuum discharge lever 2 that allows the unlocking of the suction cup 6 grip by letting air in from the outside, a lever that is connected to the pneumatic system and protruding from the lower side of the plate 4.

In turn, the plate 4 is positioned by means of a fixing nut 8 to the pneumatic positioner 30.

In particular, the pneumatic positioner 30 is a rapid positioning device, transportable and anchored in its base to workbenches.

The plate 4 in the centre of its lower part is connected to a shaft that derives from the heart of the pneumatic positioner and that thanks to a spherical play 40 can be tilted and oriented quickly in each direction and then be blocked equally quickly pneumatically in the desired position.

These characteristics allow the musical instrument to be worked, once fixed on the platform 10, the possibility of being oriented, rotated and tilted, reaching the most suitable position for each operation.

This translates in other words into the very advantageous possibility given by the present positioner in being able to change the position of the instrument very quickly—it is sufficient to press the foot valve 50 and modify the position of the aforementioned instrument even a few millimetres manually, it is therefore possible to make positional changes even very small, in the range of a few millimetres (beyond the larger ones, of course), thanks to the pneumatic positioner 30 which allows the plate 4 a 360° freedom of rotation, and of inclination in all directions of 35° with respect to the vertical axis, therefore being able to lock the position at any point (as better defined by the description of the figures, and as very different from the known art).

In the assembly of the platform 10, the plate 4 is fixed to the pneumatic positioner 30 by means of the fixing nut 8 creating a system connected to the pneumatic positioner 30.

The platform 10 is powered by a compressed air source by connecting it to the compressed air plug-in 3.

In this way the system composed of the platform 10 connected to the pneumatic positioner 30 is ready to work.

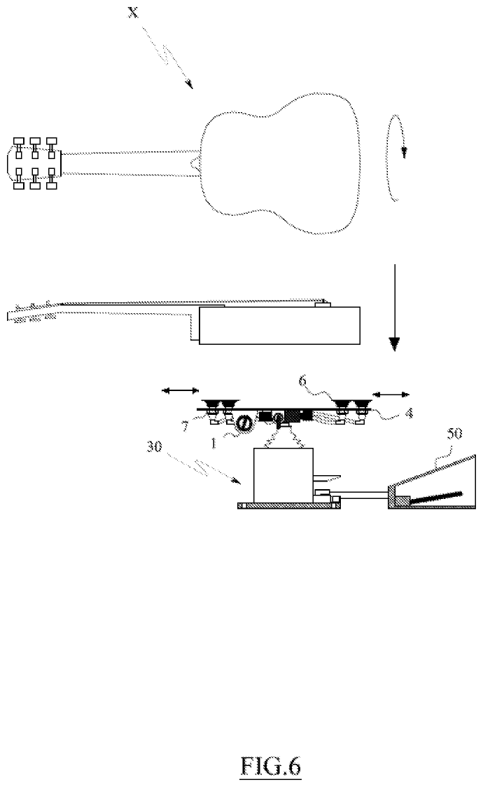

Using the movement characteristics of the pneumatic positioner 30 it is possible to orient the platform 10 with the hands in the most comfortable and ergonomic position to fix a musical instrument X thereon, as for example visible in FIG. 6.

To do this we proceed to check the dimensions of the body of the musical instrument X and to adjust the position of the suction cups 6 by moving them along the sliding through-holes 5, then locking them each by means of the respective ring nut 7 in the best position so that the rear side of the body of the musical instrument X rests well on all four suction cups 6.

Once the correct position of the suction cups 6 has been found, the rear part of the body of the musical instrument X rests on them, verifying that the resting body covers the entire surface of each of the suction cups 6.

The consensus lever 1 is therefore actuated to generate the vacuum and instantly block the instrument X thanks to the formation of the depression that is formed at the centre of each of the four suction cups 6 and that is produced by the pneumatic system 20 located below the plate 4.

After checking the stability of the instrument with the hands, the consensus lever 1 is again acted on, returning it to the initial position.

There is also a safety system provided by a self-priming valve that is located inside the pneumatic system 20, which allows to detect any pressure losses due to a non-perfect adherence of the suction cups 6 to the body of the musical instrument X and instantly allows to restore the vacuum force until a new and better adherence of the instrument X to the suction cups 6.

The musical instrument X once fixed on the platform 10 can be oriented, rotated and tilted since it exploits the characteristics of freedom of movement and of stopping and quick locking in position of the pneumatic positioner 30 and of the ball clearance 40.

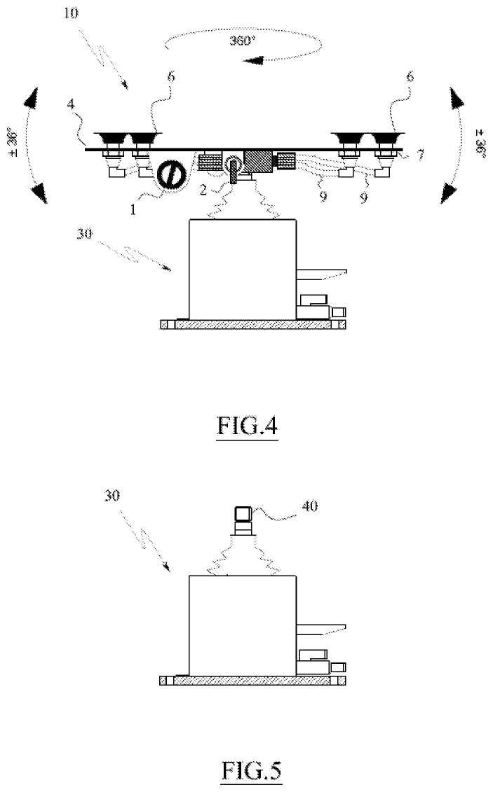

As indicated, for example, in FIG. 4 the pneumatic positioner 30 allows the plate 4 a 360° freedom of rotation, and of inclination in all directions of 35° with respect to the vertical axis.

This allows freedom of work on the musical instrument X on the entire upper part (handle and body) and on the entire lateral band of its body.

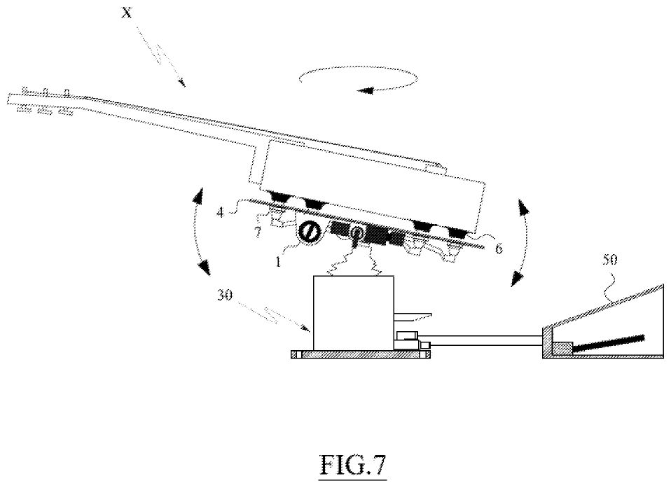

The freedom of movement of the pneumatic positioner 30 is given by means of a foot valve 50 (FIG. 7), the device “unlocks” and is free to move its own shaft to which the platform 10 is anchored.

The platform 10 that holds the musical instrument X is oriented using the hands in the most comfortable and ergonomic position to work.

The foot is removed from the foot valve and the positioner 30 quickly returns to the “locked” state while maintaining the chosen position.

This allows the operator to move the musical instrument X in the most comfortable position to perform different types of processing on it.

The detachment of the musical instrument X from the platform 10 takes place by acting on the discharge lever 2 connected to the pneumatic system 20 which opens the circuit by cancelling the force of the vacuum and instantly freeing the musical instrument X from adherence to the suction cups 6.

Once the musical instrument X has been released, the discharge lever 2 must be returned to its initial position of closing the pneumatic circuit.

The platform system 10 connected to the pneumatic positioner 30 is thus ready to accept a new musical instrument.

In a variant of the invention, instead of the pneumatic system generating the vacuum, it is possible to use an electric vacuum pump connected to the four suction cups.

The invention is therefore configured as a support base that receives and holds fixed the stringed musical instruments by retaining them in the rear surface part of their body thanks to the force of the vacuum.

Naturally, amendments or improvements may be made to the invention as described, dictated by contingent or particular reasons, without thereby departing from the scope of the invention as claimed below.

1. Platform (10) for fixing musical instruments (X), wherein said platform (10) comprises a pivoting plate (4) provided with a plurality of suction cups (6) for supporting and gripping a musical instrument (X), characterized in that each of said suction cups (6) has an adjustable position on the surface of said plate (4), and wherein each of said suction cups (6) is connectable by means of a respective air connection tube (9) to a compressed air vacuum generation system (20) for fixing said musical instrument (X) and where said platform (10) includes a consensus lever (1) that activates the pneumatic system (20) to generate the vacuum and where said platform (10) includes a vacuum discharge lever (2) that allows the suction cups (6) to be unlocked by letting air in from the outside.

2. Platform (10) as in claim 1, wherein each of said suction cups (6) is slidable along a respective through-hole (5) formed on the plate (4) and is fixable in position by means of a respective fixing ring nut (7).

3. Platform (10) as in preceding claims, wherein the suction cups (6) connected to the vacuum generation system (20) are made of soft anti-trace rubber with the function of supporting the body of the instruments and holding it with the force of the vacuum.

4. Platform (10) as in preceding claims, wherein the vacuum generation system (20) is a pneumatic system connectable to a pressurized air source for generating a vacuum by means of the Venturi principle.

5. Platform (10) as in preceding claims, wherein said plate (4) has a plug-in connection (3) in which a pipe connected to a compressed air source is insertable to supply the pneumatic system (20).

6. Platform (10) as in claim 1, wherein said plate (4) is connectable to the shaft of a pneumatic positioner (30) by means of a ball joint (40) and said shaft can be inclined and oriented in any direction and locked pneumatically in the desired position and with it said platform (10).

7. Platform (10) as in claim 7, wherein the consent to the freedom of movement of the pneumatic positioner (30) to which the platform (10) is connectable can be given by means of a foot valve (50) and the locking of the pneumatic positioner (30) can be done by removing the foot from the foot valve (50).

8. Platform (10) as in claim 1, wherein said platform (10) can be associated with a safety system comprising a self-priming valve located within the pneumatic system (20), which allows to detect any loss of pressure due to an imperfect adherence of the suction cups (6) to the body of the musical instrument (X) and instantaneously allows to re-establish the vacuum force until a new and better adherence of the instrument (X) to the suction cups (6).

9. Platform (10) as in claim 1, wherein the equipment (20) for generating the vacuum is an electric vacuum pump connectable to the suction cups (6).
